(19) United States
(12) Patent Application Publication
(10) Pub. No.: US 2019/0346237 A1
(43) Pub. Date: Nov. 14, 2019

(54) Laminate Structure Comprising a Nanoparticle Quasi-Thermoset Polymer

(71) Applicant: Ione Ryan, Houston, TX (US)

(72) Inventor: Ione Ryan, Houston, TX (US)

(21) Appl. No.: 16/191,408

(22) Filed: Nov. 14, 2018

Related U.S. Application Data
(60) Provisional application No. 62/707,725, filed on Nov. 14, 2017.

(51) Int. Cl. F41H 5/04; C08G 71/04; C08K 3/04; C08K 5/5419; C08K 13/02

(52) U.S. Cl. CPC F41H 5/0407; C08G 71/04; C08K 3/04; C08K 2201/011; C08K 13/02; F41H 5/0428; C08K 5/5419

(57) ABSTRACT

This disclosure relates to a laminate structure comprising a nanoparticle quasi-thermoset polymer. The laminate structure can comprise a first substrate, a second substrate, and a third substrate. The second substrate can comprise a quasi-thermoset polyurethane polymer, carbon nanoparticles, ultraviolet stabilizer aids, siloxane aids, and dispersion aids. The second substrate can be between the first substrate and the third substrate.

### CROSS REFERENCE TO RELATED APPLICATIONS

This patent application claims the benefit of U.S. Prov. Ser. No. 62/707,725 filed Nov. 14, 2017. The above application is incorporated by reference herein.

### FIELD OF THE INVENTION

The present invention relates generally to novel positioning, application and manufacture of a polyurethane polymer material that is a cast aliphatic urethane, quasi-thermoset material with an ultra-high modulus, super elastic shape memory, carbon nanoparticles, UV inhibitors, siloxane aids and dispersion aids compounded together and used as an interface material and stabilizer between two substrates laminated under heat and pressure to disperse the energy over the entire surface of the laminated substrate to increase tear strength of a fabric that has been cut with an automated machine, reduce the trauma or back face deformation resulting from the projectile impact and to better manage the chain of events that need to occur to stop a projectile.

### BACKGROUND

Humans throughout recorded history have used various types of materials as body armor to protect themselves from injury in combat and other dangerous situations. The first protective clothing and shields were made from animal skins. As civilizations became more advanced, wooden shields and then metal shields came into use. Eventually, metal was also used as body armor, What we now refer to as the suit of armor associated with the knights of the Middle Ages. However, with the invention of firearms around 1500, metal body armor became ineffective. Then only real protection available against firearms were stone walls or natural barriers such as rocks, trees, and ditches.

One of the first recorded instances of the use of soft body armor was by the medieval Japanese, who used armor manufactured from silk. It was not until the late 19th century that the first use of soft body armor in the United States was recorded. At that time, the military explored the possibility of using soft body armor manufactured from silk.

The U.S. Patent and Trademark Office lists records dating back to 1919 for various designs of bullet proof vests and body armor type garments.

The next generation of anti-ballistic bullet proof vest was the World War II “flak jacket” made from ballistic nylon. The flak jacket provided protection primarily from ammunitions fragments and was ineffective against most pistol and rifle threats. Flak jackets were also very cumbersome and bulky.

It would not be until the late 1960s that new fibers were discovered that made today's modern generation of cancelable body armor possible. The National institute of Justice or NH initiated a research program to investigate development of a lightweight body armor that on-duty policemen could wear full time. The investigation readily identified new materials that could be woven into a lightweight fabric with excellent ballistic resistant properties. Performance standards were set that defined ballistic resistant requirements for police body armor.

In the 1970s, one of its most significant achievements in the development of body armor was the invention of DuPont's Kevlar ballistic fabric. Ironically, the fabric was originally intended to replace steel belting in vehicle tires. By 1973, researchers at the Army's Edgewood Arsenal responsible for the bullet proof vest design had developed a garment made of seven layers of Kevlar fabric for use in field trials. It was determined that the penetration resistance of Kevlar was degraded when wet.

However, aramid materials such as Kevlar and UHMWPE materials such as Dyneema or Spectra or Tensylon do not transfer the load of an impact until the material is stretched.

In the 1990's, an ultra-high-molecular-weight polyethylene (UHMWPE, UHMW) which is a subset of the thermoplastic polyethylene was introduced into the market. It's a lightweight high-strength oriented-strand gel spun through a spinneret. These common name brands for these aramid materials are Dyneema, Spectra and Tensylon. Dyneema was invented by Albert Penning's in 1963 but made commercially available by DSM in 1990. For personal armor, the fibers are, in general, aligned and bonded into sheets, which are then layered at various angles to give the resulting composite material strength in all directions.

Impact resistant glass laminates were first introduced in the early 1900s and are well known in the art today for use in safety and security glass applications and have been traditionally constructed using alternating layers of glass and plastic sheeting in the form of thermosets, or thermoplastics with adhesive and or heat bonding interlays. Glass, in a broad sense encompasses every solid that possesses a non-crystalline structure that transitions toward a liquid state when heated toward that given materials melting point.

However, excessive layering of glass and polycarbonate or acrylic sheets creates problems. First, using such materials, the weight and thickness of the transparent laminar assembly requires a heavily engineered and reinforced support structure. Next, such laminar assemblies suffer delamination in the presence of heat, either localized heat from high-velocity projectile, heat from the bonding process, or ambient heat from, for example, desert environments. Additionally, current transparent laminar structures also suffer from other safety concerns such as leaching of biphenyl “A's”. Such characteristics decrease life cycle of the systems and structural stability, ultimately reducing or negating their effectiveness.

Other materials such as aromatics and ether-based have exhibited a great resistance to heat and can provide desirable mechanical properties of greater elasticity and lighter weight. However, heretofore, such compositions have not been suitable for use in transparent armor because over time light transmissiveness degrades.

### SUMMARY OF THE INVENTION

The disclosure relates to managing energy producing events by catching and disbursing the kinetic energy and force of a projectile on impact and managing the trajectory of the projectile allowing more time for the event to occur by positioning an application of a carbon nanoparticle thermoplastic elastomer layer comprised of an ultra-high modulus, super elastic shape memory thermoplastic polyurethane with carbon nanoparticles; with a UV stabilizer and a siloxane process aid with multi-functional benefits including, but not limited to, process aids and dispersion aids between the inner side of a substrate or material and used as an interface between two substrates or materials to disperse the energy over the entire surface of the laminated substrate; increase tear strength when used with fabrics and reduce the trauma or back face deformation resulting from the projectile impact. This material and positioning slows down the chain of reaction of the energy and friction of the projectile upon impact and reduces the projectile force penetration through the substrate or material to reduce the back-face deformation or trauma upon impact. The added benefit of using a carbon nanoparticle based thermoplastic elastomer layer gives added strength to the laminate's substrate or material. Aramid materials such as a Kevlar and UHMWPE materials such as a Dyneema or Spectra Aramid materials won't transfer the force of the impact until the material is stretched. The integration or functionalization of carbon nanoparticles in the UHMWPE and a siloxane process aid and dispersion aid will transfer the force immediately. Integrating or functionalizing nanoparticles into the resin compound will produce a much more effective result.

The disclosure further teaches for purposes of summarizing the invention, certain aspects, advantages, and novel features of the invention have been described herein. It is to be understood that not necessarily all such advantages may be achieved in accordance with any one embodiment of the invention. This, the invention may be embodied or carried out in a manner that achieve or optimizes one advantage or group of advantages as taught herein without necessarily achieving other advantages as may be taught or suggested herein.

The disclosure further teaches it should also be noted that the term “projectile” may refer to any object that may strike the surface of a laminated assembly transparent or opaque and cause degradation or failure. These may include projectiles such as bullets, shrapnel, through objects such as bricks, stones and other similar object and self-propelled items such as RPG's, IED's, missiles and other rocket like projectiles. Projectiles may also include objects that become self-propelled by an Act of God or nature as a result of severe weather conditions such as tornadoes, hurricanes, sand storms, typhoons and high winds. Projectiles may also include objects used directly strike the surface of the assembly such as bats, brick, metal objects, knives, spears, wooden clubs, etc. Projectiles may also include objects that come into contact with the assembly if used in a vehicle and that vehicle was to become part of an accident or intentional hazard.

The disclosure further teaches these, and other embodiments of the present invention will also become readily apparent to those skilled in the art from the following detailed description of the embodiments having reference to the attached figures, the invention not being limited to any embodiment(s) disclosed.

The disclosure further teaches these and other embodiments of the present invention will also become readily apparent to those skilled in the art from the following detailed description of the embodiments having reference to the attached figures, the invention not being limited to any embodiment(s) disclosed.

### BRIEF DESCRIPTION OF THE DRAWINGS

FIG. 1 illustrates an embodiment of a laminated structure.

### DETAILED DESCRIPTION

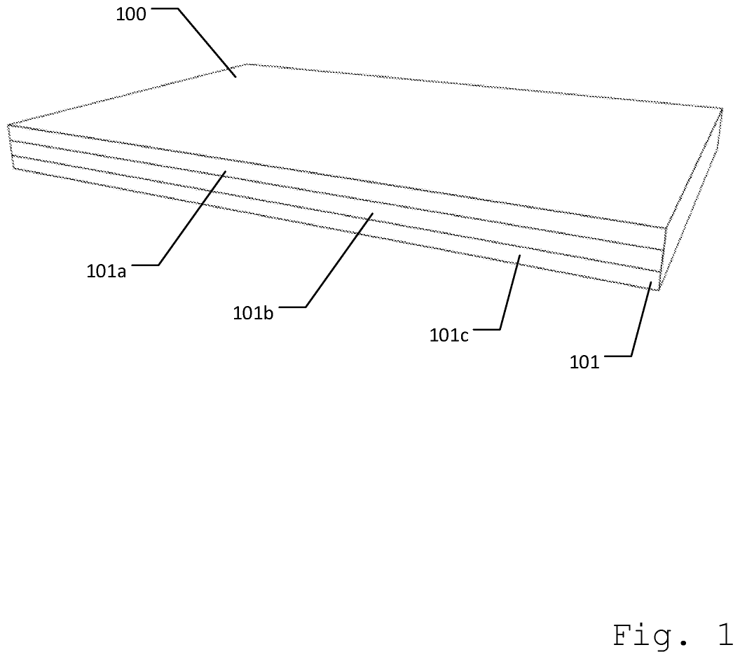

The following description is presented to enable any person skilled in the art to make and use the invention as claimed and is provided in the context of the examples discussed, below, variations of which will be readily apparent to those skilled in the art. In the interest of clarity, not all feathers of an actual implementation are described in this specification. It will be appreciated that in the development of any such actual implementation (as in any development project), design decision must be made to achieve the designers' specific goals (e.g., compliance with system- and business-related constraints), and that these goals will vary from one implementation to another. It will also be appreciated that such development effort might be complex and time-consuming but would nevertheless be a routine undertaking for those of ordinary skilled in the field of the appropriate art having the benefit of this disclosure. Accordingly, the claims appended hereto are not intended to be limited by the disclosed embodiments but are to be accorded their widest scope consistent with the principles and features disclosed herein. The terminology used herein is for the purpose of describing embodiments only and is not intended to be limiting of the invention. As used herein, the term “and/or” includes any and all combinations of one or more of the associated listed items. The various embodiments of the present invention and their advantages can be well understood by referring to FIG. 1 of the drawing. However, the elements of the drawing are not necessarily to scale, emphasis instead being placed upon clearly illustrating the principles of the invention. The invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

FIG. 1 illustrates a laminated structure 100. Laminated structure 100 can comprise a plurality of substrates 101. In one embodiment, substrate 101 can comprise a first substrate 101a, a second substrate 101b, and a third substrate 101c. In such embodiment, first substrate 101a can be a rigid structure. Non-limiting examples of a rigid structure can include glass, polycarbonate, acrylic, or plastic. Glass as discussed within this disclosure assumes a very broad term as there are many base material combinations for glass that one skilled in the art could devise and utilize. Glass material combinations could result in a transparent, semi-transparent, colored, non-colored or opaque material. For example, bullet resistant glass is sometimes constructed with several glass sheets connected together with thin sheets of polyvinyl butyral, or polyester interposed there between with a polycarbonate or acrylic layer bonded on the inside face of the final glass sheet using a thermoplastic polyurethane layer. A polycarbonate or acrylic layer provides additional strength, and to a small degree, elasticity, to the glass upon impact but is used primarily to provide good resistance to spalling. In another embodiment, first substrate 101a can comprise of a non-rigid material such as fabric, animal products, plant materials, minerals, or synthetic materials. Examples include tactical and non-tactical nylons and ballistic fabrics. Similarly, substrate layer 101c can be a rigid or non-rigid structure as described above, and can be transparent or opaque.

Second substrate 101b can in reality be a single layer or multiple layers. Second substrate 101b can comprise of a quasi-thermoset polyurethane polymer. Unlike true thermoset materials, this polyurethane polymer exhibits thermoplastic characteristics as far as flow, elasticity and “self-healing” shape memory. When positioned between substrates to form a laminated structure, the substrates can provide structural stability to the polymer, reducing gross deformation to the laminated structure related to kinetic energy at a point of impact. During an impact event, second substrate 101b increases material interface between the first substrate 101a and third substrate 101c, allowing for local impact energies to be dispersed and dissipated over a greater surface area thereby improving management of the impact event. This is a result of super elastic shape memory provided by the extremely long molecular chain associated with the polymer and is measured at a 27 in accordance with measurements contained in the ASTM D790. Second substrate 101b may be between 0.002 inches to about 0.008 inches thick, depending upon the desired properties to be achieved. Laminate structure 100 can be assembled by a conventional process using iterative application of heat (e.g. up to about 360 degrees Fahrenheit and pressure (ranging from 10 psi to 60 psi).

One example of such polymer is a cast aliphatic urethane. Further, such cast aliphatic urethane can be an ultra-high modulus, super elastic shape memory thermoplastic polyurethane (UHMTPE). Second layer 101b can further comprise carbon nanoparticles in a range of 0.001%-1% by volume, an anti-oxidant ultra-violet (UV) stabilizer aid in a range of 0.001%-3% volume, and/or a siloxane process aid and a dispersion aid in a range of 1%-3% by volume. In a preferred embodiment, the UV stabilizer and siloxane process aid and dispersion aide is not more than 3% of the mixture by volume. UV absorber filters harmful UV light and can prevents discoloration that degrades light transmission and prevents delamination when heating. The characteristics of the UHMTPE can be achieved with an ether-based, rather than ester-based aromatic thermoplastic, long molecular chain, polyurethane composition. The anti-oxidant prevents thermally induced oxidation of polymers during coating and heat lamination and traps free radicals formed during heating in the presence of oxygen and prevent discoloration and change of mechanical properties incumbent to the polymer. In other words, mechanical properties such as elasticity and light transmissiveness are preserved. When used together they have complimentary synergistic effect.

Carbon nanoparticles can be lightweight, long, high surface area materials with exceptional mechanical strength allowing even longer molecule chains to form, thus further improving covalent bonds. Carbon nanoparticles may be carbon nanotubes, single walled carbon nanotubes, multi-walled carbon nanotubes, graphene, graphene sheets, graphene nanoribbons, or any combination thereof. The addition of carbon nanoparticles encased, integrated or functionalized in the base resin can be beneficial in areas of shock absorption and energy dispersion. Characteristics of carbon nanoparticles enable them to impart strength, toughness, and crack/impact resistance to a variety of materials. Carbon nanoparticles enable load transfer and energy dissipation between layers and have shown an increase in ballistic resistance performance, shock absorption and improved strength and fatigue life and enhance chemical and mechanical covalent bonding. The addition of carbon nanoparticles can be beneficial in enhancing tear strength when two materials are laminated together.

First substrate 101a, second substrate 101b, and third substrate 101c can be laminated together using heat up to 360 F and pressure up to 60 psi. In one embodiment, laminate structure can reduce back face deformation or trauma by absorbing the energy force at the point of impact and dispersing it over the entire surface area when laminated between the inner sides of a rigid or non rigid substrate.

In another embodiment laminate structure 100 can improve tear strength of laminated fabrics where attachment openings singular or multiple are cut using an automated laser cutting process and tested with an Instron 3366 10 kN Dual Column Testing System; used in conjunction with Webbing Capstan Grips, webbing style 1 in 63361 (MIL-SPEC A-A-55301 T-III).

Lastly, laminate structure, in one embodiment, can be a better manager of the chain of events necessary to stop a projectile in a laminated rigid or non-rigid substrate by absorbing the force of the impact at the point of impact and increasing material interface between the layers and allows for local impact energies to be dispersed and dissipated over a greater surface area thereby improving management of the impact event.

While embodiments of the invention have been described, it will be understood, however, that the invention is not limited thereto, since modification may be made by those skilled in the art, particularly in light of the foregoing teachings. It is, therefore, contemplated by the appended claims to cover any such modifications that incorporate those features or those improvements that embody the spirit and scope of the present invention.

1. A laminate structure comprising
a first substrate;
a second substrate comprising
a quasi-thermoset polyurethane polymer,
carbon nanoparticles
ultraviolet stabilizer aids,
siloxane aids, and
dispersion aids; an
a third substrate, said second substrate between said first substrate and said third substrate.

2. The laminate structure of claim 1, wherein said carbon nanoparticles are in a range of 0.001% to 1% of said second substrate by volume.

3. The laminate structure of claim 1, wherein said UV stabilizer is in a range of 0.001% to 3% of said second substrate by volume.

4. The laminate structure of claim 1, wherein said siloxane aids and said dispersion aids are in a range of 1% to 3% of said second substrate by volume.

5. The laminate structure of claim 1 wherein said UV stabilizer, said siloxane aids, and said dispersion aids together are 3% or less of said second substrate by volume.

6. The laminate structure of claim 1 wherein said first substrate is rigid.

7. The laminate structure of claim 6 wherein said first substrate is glass.

8. The laminate structure of claim 1 wherein said first substrate is non-rigid.

9. The laminate structure of claim 1 wherein said third substrate is rigid.

10. The laminate structure of claim 9 wherein said third substrate is glass.

11. The laminate structure of claim 1 wherein said second substrate is non-rigid.

12. The laminate structure of claim 1 wherein said quasi-thermoset polyurethane polymer is a cast aliphatic urethane.

13. The laminate structure of claim 12 wherein said cast aliphatic urethane is an ultra-high modulus, super elastic shape memory thermoplastic polyurethane (UHMTPE)

14. The laminate structure wherein said second substrate is between 0.02 and 0.08 inches thick.
